(19) United States
(12) Patent Application Publication
(10) Pub. No.: US 2009/0268442 A1
(43) Pub. Date: Oct. 29, 2009

(54) SINGLE SIDED POWER SUPPLY DEVICE OF A LAMP STRUCTURE

(75) Inventors: Cheng Hsiu Wu, Taipei City (TW); Chih Chun Li, Taipei City (TW)

Correspondence Address: NIKOLAI & MERSEREAU, P.A., 900 SECOND AVENUE SOUTH, SUITE 820, MINNEAPOLIS, MN, 55402, US

(73) Assignee: FETON LIMITED BERWELL HARDWARE LTD., Taipei City (TW)

(21) Appl. No.: 12/132,896

(22) Filed: Jun. 4, 2008

(30) Foreign Application Priority Data
Apr. 24, 2008 (TW) 097207014

(51) Int. Cl. F21L 4/00; F21S 9/00

(52) U.S. Cl. 362/194; 362/227

(57) ABSTRACT

The present invention relates to a single sided power supply device of a lamp structure. The lamp structure is mainly installed inside a cabinet, and by opening the cabinet door will enable the electrical circuit of the lamp structure to be a close circuit; vise versa, closing the cabinet door will result in the open circuit of the electrical circuit of the lamp structure. When the electrical circuit is a close circuit, the light emitting part of the lamp structure will generate light to illuminate the internal space of the cabinet so as clearly view the objects location in the cabinet, furthermore, also to prevent from a situation of fault connection by using the single sided power supply device.

### FIELD OF THE INVENTION

The present invention relates to a single sided power supply device of a lamp structure, particularly a lamp structure installed internal to a cabinet, also to prevent from a situation of fault connection by using the single sided power supply device.

### BACKGROUND OF THE INVENTION

Our everyday lives have become more and more convenient by each day, where we can see significant improvements to what we eat, what we wear, where we live, or how we travel; even still, the limitless human desire will not be easily satiated and we will continue take note of every single inconveniences in our lives in search of quick and easy solutions; as such, cabinets commonly present in homes or offices are usually available for storing things and objects, and are occasionally placed at locations low in visible light; these cabinets usually do not feature lighting equipment and the cabinets that are installed with lighting equipments are usually higher in cost, and some even require external power sockets to be able to utilize the lighting equipments therefore these cabinets are not practical in reality; in light of this, the inventor after various modifications and research has created the innovative lamp structure.

### SUMMARY OF THE INVENTION

The present invention relates to a single sided power supply device of a lamp structure. The primary object of the present invention is to provide a lamp structure that provides illumination when user opens the cabinet door.

The present invention relates to a single sided power supply device of a lamp structure. Another object of the present invention is to increase the possibility of preventing fault connection by using the single sided contacting method.

The present invention relates to a single sided power supply device of a lamp structure, comprising a case including a housing structure with a hollow part and the portion of the surface of the case includes an opening part penetrating through to the hollow part; a light emitting part including a plurality of light emitting elements installed on the surface of the box; a power supply as the main power source to the entire structure; an electrical circuit electrically connected in between the light emitting part and the power supply member, wherein the electrical circuit comprises a first electric terminal and a second electric terminal, the first electric terminal and the second electric terminal being generally in electrically disconnected state; a sliding element, made of a conductive material, is placed inside the case and is restricted between a first position and a second position; an extension part, one end of the extension part is connected to the sliding element and the other end protrudes through the opening part and protrudes to the surface of the case; and a spring element that is a mechanical element with elastic recovery force, the spring element is being a conductive material, one end of the spring element is installed to the case, and is electrically connected to the first electrical terminal of the electrical circuit, whereas the other end of the spring element is secured to the sliding element, wherein the sliding element can select an either state of a open circuit state or a close circuit state between the first electrical terminal and the second electrical terminal, in which, the close circuit state is the state of the other end of the sliding element is connected to the second electrical terminal, the open circuit state is the state of the sliding element is disengaged from the second electrical terminal; the first position corresponds to the open circuit state selected by the sliding element, and the second position corresponds to the close circuit state selected by the sliding element; the protruded position of the extension pail relative to the surface of the case corresponds to one of the first position and second position of the sliding element, to determine whether if the light emitting element receives power for generating the light for illumination.

The objects, features and method of the invention as well as implementation of the invention are described in detail below with embodiments in reference to the accompanying drawings.

### BRIEF DESCRIPTION OF THE DRAWINGS

FIG. 1 is the exploded view of the single sided power supply device of a lamp structure according the present invention;

FIG. 2 is the assembly view of partial components of the single sided power supply device of a lamp structure according the present invention;

FIG. 3 is the assembly view of the single sided power supply device of a lamp structure according the present invention;

FIG. 4 is the electrical circuit diagram of the single sided power supply device of a lamp structure according the present invention;

FIG. 5 is the schematic view for the first position of the single sided power supply device of a lamp structure according the present invention; and

FIG. 6 is the schematic view for the second position of the single sided power supply device of a lamp structure according the present invention.

### DETAILED DESCRIPTION OF THE INVENTION

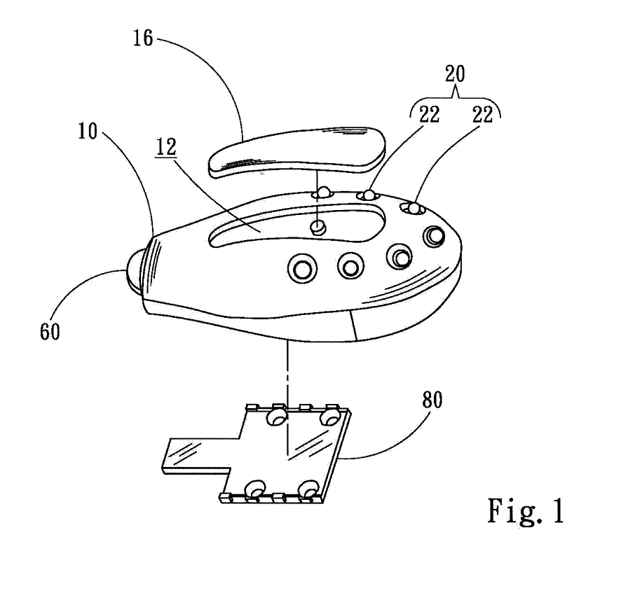

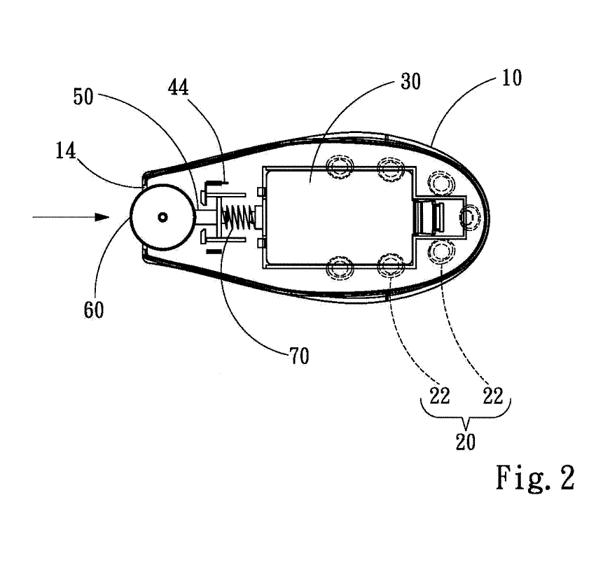

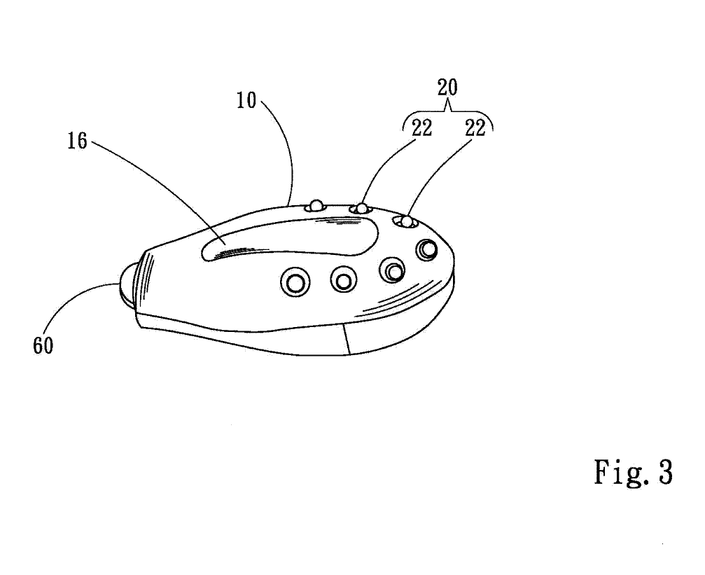

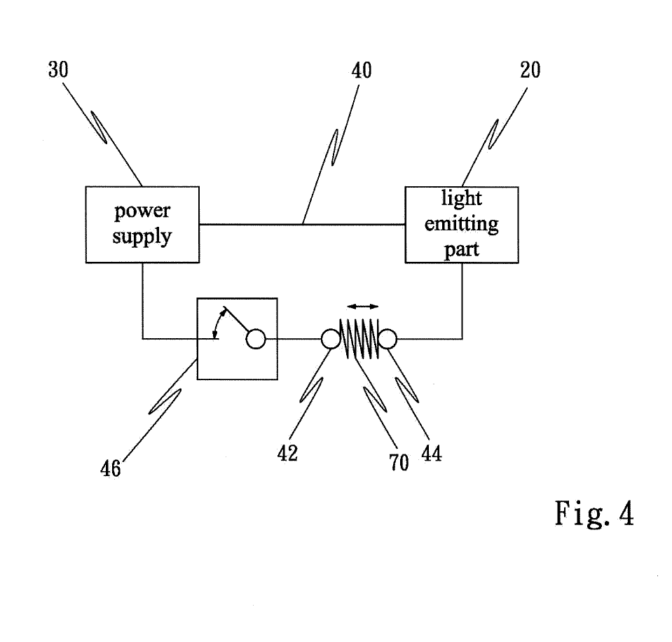

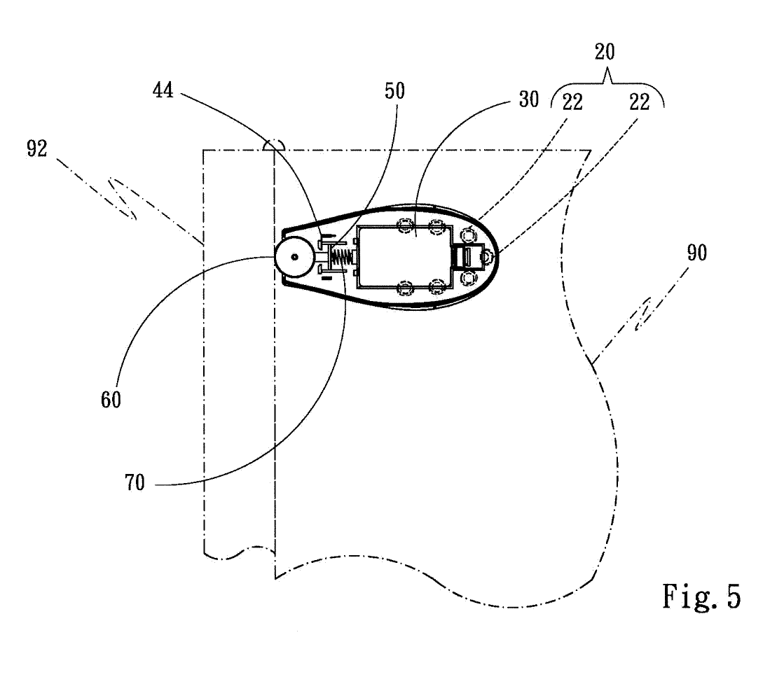

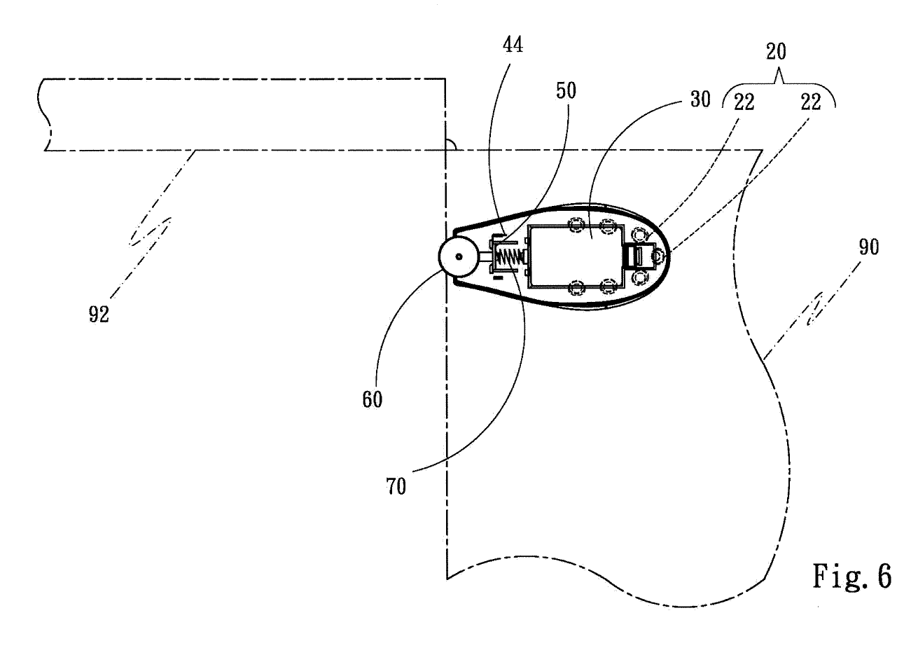

Referring to FIG. 1 to FIG. 6, FIG. 1 is the exploded view of the single sided power supply device of a lamp structure according the present invention; FIG. 2 is the assembly view of partial components of the single sided power supply device of a lamp structure according the present invention; FIG. 3 is the assembly view of the single sided power supply device of a lamp structure according the present invention; FIG. 4 is the electrical circuit diagram of the single sided power supply device of a lamp structure according the present invention; FIG. 5 is the schematic view for the first position of the single sided power supply device of a lamp structure according the present invention; and FIG. 6 is the schematic diagram for the second position of the single sided power supply device of a lamp structure according the present invention. The present invention relates to a lamp structure (1) comprises a case (10), a light emitting part (20), a power supply (30), an electrical circuit (40), a sliding element (50), an extension part (60), and a spring element (70); the embodiment of the present invention is described in details below.

In the above-mentioned inventive lamp structure (1), the case (10) includes a housing structure with a hollow part (12), on the partial surface of the case (10) there being provided an opening part (14) that penetrates through the casing and communicates with the hollow part (12), the case (10) further include a push-button part (16).

In the above-mentioned light emitting part (20), the light emitting part (20) including a plurality of light emitting elements (22) (seven light emitting elements are used in the present invention) installed on the surface of the case (10).

In the above-mentioned power supply (30), the power supply (30) is the power source required by the whole circuit, more particularly, in an embodiment of the power supply (30) of the present invention, the power supply member (30) is assembled in the hollow part (12) of the case (10). The power supply member (30) comprises a battery holder and can utilize common battery (not shown in figures) as the power source. Furthermore, the power supply (30) can also be an external power source to the case (10). Specifically, the power supply, (30) is an external battery pack or an adapter electrically connected to the city power system, the power supplied by the power supply (30) is directed to the electrical circuit (40) through the electrical connection to supply the power needed by the light emitting part (20).

In the above-mentioned electrical circuit (40), the electrical circuit (40) is the main electric circuit connecting the light emitting part (20) to the power supply (30), and the electrical circuit (40) comprises a first electrical terminal (42) and a second electrical terminal (44), where the first electrical terminal (42) and the second electrical terminal (44) are open circuited in between. Furthermore, the above-mentioned second electrical terminal (44) is a plate with conductive properties; the plate can be made with conductive materials, or by disposing the conductive materials on a non-conductive material substrate. The electrical circuit further comprises a switch (46), the switch (46) is another control of the state of the electrical circuit (40) to be either open circuit or close circuit, the execution of the switch (46) can be controlled by the push-button part (16).

In the above-mentioned sliding element (50), the sliding element (50) is installed internal of the case (10) and is restricted between a first and a second position, the sliding element (50) is made with conductive materials, or by disposing the conductive materials on a non-conductive material substrate.

In the above-mentioned extension part (60), one end of the extension part (60) is connected to the sliding element (50), and the other end of the extension part (60) protrudes the opening part (14) and protrudes to the surface of the case (10). The extension part (60) is in the form of circular plate, also the contacting joint between the sliding element (50) and the extension part (60) is in the form of circular arch; the purpose of it is to make the sliding element (50) to joint onto the extension part (60) easily.

In the above-mentioned spring element (70), the spring element (70) is a mechanical element with elastic recovery force, the spring element (70) is being a conductive material, one end of the spring element (70) is installed to the case (10), and is electrically connected to the first electrical terminal (42) of the electrical circuit (40), whereas the other end of the spring element (70) is secured to the sliding element (50), both of the sliding element (50) and the spring element (70) are conductive materials, therefore, they can be connected electrically. The sliding element (50) can select an either state of a open circuit state or a close circuit state between the first electrical terminal (42) and the second electrical terminal (44), in which, the close circuit state is the state of the sliding element (50) being connected to the second electrical terminal (44), the open circuit state is the state of the sliding element (50) being disengaged from the second electrical terminal (44); the first position corresponds to the open circuit state selected by the sliding element (50), and the second position corresponds to the close circuit state selected by the sliding element (50), thereby formed contacting of the single sided power supply; the protruded position of the extension part (60) relative to the surface of the case (10) corresponds to one of the first position and second position of the sliding element (50).

Referring to FIG. 5 and FIG. 6 again, FIG. 5 and FIG. 6 are the schematic view for the first position and the second position of the single sided power supply device of a lamp structure installed in a cabinet (90). The lamp structure (1) is installed internally to a cabinet (90) and the installation method comprises securing a stationary board (80) with screws or adhered inside the cabinet (90) (is not relevant to characteristic of the present invention, so no further description in the detail). Next as described above, the case (10) is assembled on the stationary board (80), when installed in the cabinet (90), the opening part (14) of the case (10) will face toward the external space of the cabinet (90), while the side of the case (10) provided with the light emitting part (20) will face the internal space of the cabinet (90), when a door (92) on the cabinet (90) is closed, the door (92) will push against the extension part (60) to move the extension part (60) and the sliding element (50) to the inside of the case (10), thereby reaching to the default first position; the spring element (70) will also be compressed by pushing, therefore the spring element (70) electrically connected to the first electrical terminal (42) will disengage from the plate-formed second electrical terminal (44), resulting in an open circuit state where the light emitting part (20) will not generate the light illumination; in the contrast, if the cabinet (90) is opened, the door (92) will release the extension part (60) for the spring element (70) to recover from the compression and push on the sliding element (50), subsequently the extension part (60) will protrude from the opening part (14), resulting in the sliding element (50) to move to reach the default second position; hence the sliding element (50) will come in contact with the second electrical terminal (44), at this time the whole circuit exhibits open-circuit state, and the light emitting part (20) can generate the light illuminated to the internal space of the cabinet (90), moreover, the user may also further control the existence of the light of the light emitting part (20) for illumination by the push-button part (16).

Therefore, the present invention provides a novel single sided power supply device of a lamp structure, can convenience the user to illuminate the internal space of the cabinet; thereby the present invention is highly improved and conforms to the conditions of applied patents, and hereby this patent application is claimed in accordance to regulations.

The present invention has been described by way of example while a preferred embodiment is provided for illustration purposes only, it should be understood that the invention is not limited thereto; to the contrary it is intended to cover various changes and modifications. Therefore, the scope of the appended claims should be accorded the broadest interpretation so as to encompass all such changes and modifications.

What is claimed is:

1. A single sided power supply device of a lamp structure, comprising:
a case including a housing structure with a hollow part, and a portion of the surface of the case including an opening part penetrated through to the hollow part;
a light emitting part including a plurality of light emitting elements, and the light emitting elements installing on the surface of the case;
a power supply, as the main power source of the entire structure.
an electrical circuit, mainly for electrically connecting the light emitting part to the power supply, wherein, the electrical circuit comprises a first electrical terminal and a second electrical terminal, the first electrical terminal and the second electrical terminal forming an open circuit in between;
a sliding element installing inside the case and restricting in between a first position and a second position;
an extension part, one end of the extension connecting to the sliding element and the other end extending through the opening part and protruding out the surface of the case; and
a spring element, as a mechanical element with elastic recovery force, the spring element being a conductive, material, one end of the spring element affixing to the case and electrically connecting to the first electrical terminal of the electrical circuit and the other end of the spring element securing to the sliding element;
wherein the sliding element can select a state of close circuit state or open circuit state between the first electrical terminal and the second electrical terminal, in which, the close circuit state being a state of the sliding element connected to the second electrical terminal, the open circuit state being a state of the sliding element disengaged from the second electrical terminal; the first position corresponding to the open circuit state selected by the sliding element and the second position corresponding to the close circuit state selected by the sliding element; and the protruded position of the extension part relative to the surface of the case corresponding to one position of the first position and second position of the sliding element.

2. The single sided power supply device of a lamp structure according to claim 1, wherein the power supply is installed internally to the case.

3. The single sided power supply device of a lamp structure according to claim 2, wherein the power supply comprises a battery holder.

4. The single sided power supply device of a lamp structure according to claim 1, wherein the extension part is in the form of circular plate.

5. The single sided power supply device of a lamp structure according to claim 4, wherein the contacting joint between the sliding element and the extension part is in the form of circular arch.

6. The single sided power supply device of a lamp structure according to claim 5, wherein the sliding element is being a conductive material.

7. The single sided power supply device of a lamp structure according to claim 1, wherein the electrical circuit further comprises a switch, the switch is another control of the electrical circuit to be either in the state of open circuit or close circuit.

8. The single sided power supply device of a lamp structure according to claim 7, wherein the case comprises a push-button part, the push-button part is a control of the execution of the switch.

9. The single sided power supply device of a lamp structure according to claim 1, wherein the spring element is being a spring.

10. The single sided power supply device of a lamp structure according to claim 1, wherein the case is further mechanically connected to a stationary board.
